(19) United States
(12) Patent Application Publication
(10) Pub. No.: US 2017/0156105 A1
(43) Pub. Date: Jun. 1, 2017

(54) REALM BASED NETWORK-ACCESS-IDENTIFIER (NAI) MODIFICATION FOR A ROAMING PARTY NEEDING TO AUTHENTICATE WITH HOME NETWORK

(71) Applicant: NOKIA SOLUTIONS AND NETWORKS OY, Espoo (FI)

(72) Inventors: Jari Pekka MUSTAJARVI, Espoo (FI); Janne Petteri TERVONEN, Espoo (FI)

(21) Appl. No.: 15/324,538

(22) PCT Filed: Jul. 7, 2014
(86) PCT No.: PCT/EP2014/064405

§ 371 Date: Jan. 6, 2017

(51) Int. Cl. H04W 48/14; H04W 48/16; H04W 12/06

(52) U.S. Cl. CPC H04W 48/14; H04W 12/06; H04W 48/16; H04W 84/12

(57) ABSTRACT

A method and apparatus can be configured to find a service broker based on at least one identifier and communication with a home service provider via this service broker. The service broker acts as a proxy service provider for a service provider like the home service provider. The method can also include determining a realm associated to the at least one identifier. The method can also include creating a network-access-identifier based on the determined realm. The method can also include transmitting the network-access-identifier to the service broker for performing authentication of the user equipment in the home service provider.

### BACKGROUND

Field

Embodiments of the invention relate to implementing a network-access-identifier mechanism when roaming.

Description of the Related Art

Wireless communication technology allows a user device or a user equipment to exchange data or access the internet. A large proportion of wireless-local-area networks (WLAN) are configured to use WLAN technology. Since its inception, WLAN has seen extensive deployment in a wide variety of contexts involving the transfer of data.

### SUMMARY

According to first embodiment, a method includes finding, by a user equipment, a service broker based on at least one identifier and communication with a home service provider via this service broker. The service broker acts as a proxy service provider for a service provider like the home service provider. The method also includes determining a realm associated to the at least one identifier. The method also includes creating a network-access-identifier based on the determined realm. The method also includes transmitting the network-access-identifier to the service broker for performing authentication of the user equipment in the home service provider.

In the method of the first embodiment, the finding the service broker comprises finding the service broker while the user equipment is roaming.

In the method of the first embodiment, the finding the service broker based on the at least one identifier comprises finding the service broker based on at least one of service-set-identifiers, homogenous-extended-service-set-identifiers, and organizational identifiers.

In the method of the first embodiment, the finding the service broker comprises finding a wireless-local-area network.

In the method of the first embodiment, the finding the service broker comprises finding a service broker based on at least one of service-set-identifiers, homogenous-extended-service-set-identifiers, and organizational identifiers in a home service provider network selection policy that is delivered to the user equipment

According to a second embodiment, an apparatus may include at least one processor. The apparatus may also include at least one memory including computer program code. The at least one memory and the computer program code may be configured, with the at least one processor, to cause the apparatus at least to find a service broker based on at least one identifier and communication with a home service provider via this service broker. The service broker acts as a proxy service provider for a service provider like the home service provider. The apparatus may also be caused to determine a realm associated to the at least one identifier. The apparatus may also be caused to create a network-access-identifier based on the determined realm. The apparatus may also be caused to transmit the network-access-identifier to the service broker for performing authentication of the apparatus.

In the apparatus of the second embodiment, the finding the service broker comprises finding the service broker while the apparatus is roaming.

In the apparatus of the second embodiment, the finding the service broker based on the at least one identifier comprises finding the service broker based on at least one of service-set-identifiers, homogenous-extended-service-set-identifiers, and organizational identifiers.

In the apparatus of the second embodiment, the finding the service broker comprises finding a wireless-local-area network.

In the apparatus of the second embodiment, the finding the service broker includes finding a service broker based on at least one of service-set-identifiers, homogenous-extended-service-set-identifiers, and organizational identifiers in a home service provider network selection policy that is delivered to the apparatus.

According to a third embodiment, a computer program product may be embodied on a non-transitory computer readable medium. The computer program product may be configured to control a processor to perform a process including finding, by a user equipment, a service broker based on at least one identifier and communication with a home service provider via this service broker. The service broker acts as a proxy service provider for a service provider like the home service provider. The process may include determining a realm associated to the at least one identifier. The process may also include creating a network-access-identifier based on the determined realm. The process may also include transmitting the network-access-identifier to the service broker for performing authentication of the user equipment. According to a fourth embodiment, a method includes binding, by a network node, at least one identifier with an associated realm. The method also includes transmitting the at least one identifier and a binding realm to a user equipment. The transmitting comprises communicating with a service broker.

In the method of the fourth embodiment, the binding comprises binding at least one of service-set-identifiers, homogenous-extended-service-set-identifiers, and organizational identifiers with the associated realm.

In the method of the fourth embodiment, the transmitting the at least one identifier to the user equipment comprises transmitting the at least one identifier in a home service provider network selection policy.

According to a fifth embodiment, an apparatus includes at least one processor. The apparatus may also include at least one memory including computer program code. The at least one memory and the computer program code may be configured, with the at least one processor, to cause the apparatus at least to bind at least one identifier with an associated realm. The apparatus may also be caused to transmit the at least one identifier and a binding realm to a user equipment, wherein the transmitting comprises communicating with a service broker.

In the apparatus of the fifth embodiment, the binding comprises binding at least one of service-set-identifiers, homogenous-extended-service-set-identifiers, and organizational identifiers with the associated realm.

In the apparatus of the fifth embodiment, the transmitting the at least one identifier to the user equipment comprises transmitting the at least one identifier in a home service provider network selection policy.

According to a sixth embodiment, a computer program product may be embodied on a non-transitory computer readable medium. The computer program product may be configured to control a processor to perform a process including binding, by a network node, at least one identifier with an associated realm. The process may also include transmitting the at least one identifier and a binding realm to a user equipment. The transmitting comprises communicating with a service broker.

### BRIEF DESCRIPTION OF THE DRAWINGS

For proper understanding of the invention, reference should be made to the accompanying drawings, wherein:

FIG. 1 illustrates a Hotspot 2.0 model in accordance with one embodiment.

FIG. 2 illustrates a Hotspot 2.0 model in accordance with another embodiment.

FIG. 3 illustrates a flow diagram of a method according to one embodiment.

FIG. 4 illustrates a flow diagram of another method according to one embodiment.

FIG. 5 illustrates an apparatus in accordance with one embodiment.

FIG. 6 illustrates an apparatus in accordance with another embodiment.

FIG. 7 illustrates an apparatus in accordance with another embodiment.

FIG. 8 illustrates an apparatus in accordance with another embodiment.

FIG. 9 illustrates an apparatus in accordance with another embodiment.

### DETAILED DESCRIPTION

Embodiments of the present invention are directed to implementing a network-access-identifier mechanism when roaming. The network-access-identifier mechanism can be used when a user equipment (UE) is roaming and using access-network-discovery-and-selection-function (ANDSF) and/or Hotspot 2.0 technologies. By using mechanisms like ANDSF and Hotspot 2.0, a network selection policy (such as a home service provider network selection policy) may be transmitted to the user equipment, as described in more detail below. When the UE performs WLAN network selection, Wi-Fi Alliance Hotspot 2.0 (HS2.0) endorses identifiers like roaming consortium Organizational Identifiers (OI) and Service-Set-Identifiers/Homogenous-Extended-Service-Set-IDs (SSID/HESSID). These identifiers may be identifiers defined in, for example, IEEE 802.11. HS2.0 may mandate support for the identifiers in Wi-Fi Alliance Passpoint service. However, when WLAN network selection is performed using these HS2.0 identifiers, and after the UE has selected a network to enter, there is no clear way to provide routable Network-Access-Identifiers (NAI) for performing authentication on the selected network. Although HS2.0 may provide routable NAIs for performing authentication by using a home NAI, this leads to problematic configuration and deployment issues when roaming consortium OIs are used for network selection. As described in more detail below, embodiments of the present invention can address some of these problematic issues.

As described in more detail below, WLAN service providers can be identified by NAI realms (each service provider typically has one or more NAI realms), can be identified by Public-Land-Mobile-Networks (PLMNs) (via 3GPP Cellular Network Access-Network-Query-Protocol (ANQP)), and/or can be identified by Operator Identifiers (OI). Roaming consortiums are identifiable by OI. The UE can search for OIs that have been configured into the UE by a home operator. However, in order to actually authenticate the UE in WLAN, the local WLAN access provider has to authenticate the UE in a home network. The UE will create a user identity including a user-identification part and a realm part. The realm part is used by the local WLAN access provider to route an authentication request to a home service provider. A NAI realm can be used to route the authentication request to the home service provider.

Access-Network-Discovery-and-Selection-Function (ANDSF) service, as described in 3GPP TS 23.402, is generally directed to data management and control functionality that is necessary to provide network discovery and selection-assistance data in accordance with an operator's policy. The ANDSF generally responds to a UE's requests for access network discovery and policy information (pull mode operation) and may be able to initiate data transfer to the UE (push mode operation), based on network triggers or as a result of previous communication with the UE. ANDSF, as described in the current 3GPP Release 12 draft specification, will generally perform service-provider selection by utilizing a special Preferred Service Providers List (PSPL). The PSPL contains a prioritized list of service providers that are preferred by a user equipment's (UE's) 3GPP home operator for performing Wireless-Local-Area-Network (WLAN) access while roaming. The service providers of the PSPL are identified by the UE via their respective realms.

These respective realms indicate service providers/domains like att.com or nai.epc.mnc<MNC>.mcc<MCC>.3gppnetwork.org, where <MNC> and <MCC> are replaced with respective mobile network and mobile country codes of the corresponding 3GPP operator, for example. In the above example, “nai.epc” may be used in 3GPP Evolved Packet Core (EPC), but older 3GPP Interworking-Wireless-Local-Area-Network (IWLAN) specification may use “wlan” instead. HS2.0 may also use “wlan” instead of “nai.epc”.

The parties that operate public WLAN networks are not necessarily the same parties as the service providers who will eventually authenticate and authorize users to enter the WLAN networks. WLAN network operators can provide the infrastructure of WLAN networks (infrastructure such as WLAN Access Points (APs) and controllers), while the WLAN service providers take care of authentication, authorization, and accounting of the users. Access points and WLAN controllers are generally operated by a same party. A thin access point (such as a lightweight Access Point (AP)) with a WLAN controller provides the same service as one thick access point (such as a standalone AP). Currently, public WLAN networks are often operated by a same party which entered into a service contract with the user. HS2.0 clearly describes a separation between a WLAN access network operator and a service contractor (such as a service provider). In accordance with HS2.0, roaming generally means that a UE uses a different network access operator than a home operator. The service provider is generally a home service provider. In accordance with 3GPP, roaming generally means that a UE uses a different service provider than a home service provider. This roaming service provider (such as a public-land-mobile-network (PLMN)) either owns the WLAN access network or has made its own agreement regarding the use of this access network. From the point of view of the access network, the roaming service provider will authenticate the user. The roaming service provider then has a roaming agreement with the home service provider and forwards authentication requests to the home service provider. 3GPP does not have a designated name for the type of roaming that is described by HS2.0. 3GPP merely describes home access networks, preferred partner access networks, and other (least preferred) access networks.

If a WLAN service provider differs from a network operator, then the WLAN service provider and the network operator generally have made/reached a roaming agreement, and the network operator will charge payment to the WLAN service provider based on this agreement. The Wi-Fi alliance HS2.0 technical specification and a related Passpoint certification program relies on this arrangement between the providers and the operators, and this model is currently adopted by ANDSF service (at least when 3GPP Release 12 is implemented).

In accordance with the current ANDSF specification, the user equipment (UE) will search through WLAN networks based on network-operator identifiers conveyed by an ANDSF Managed Object (MO) WLAN-Selection-Policy (WLANSP) node. A WLANSP node is one node out of many in the ANDSF MO. The WLANSP node is used to convey WLAN access network selection preferences and criteria to the UE. The UE will sort these networks according to WLANSP priority information (provided by the WLANSP node), and the UE chooses a WLAN network which (a) fulfils service quality conditions that are defined in the WLANSP node, and (b) is the most important WLAN network among applicable networks according to the priority information provided by the WLANSP node. If there are no networks that fulfill the highest priority criteria, then the UE can consider lower priority criteria in the priority order until a valid network has been found. The UE will then consider service providers defined in the PSPL of ANDSF, and the UE chooses the WLAN-network-supporting-service provider which is ranked the highest among all candidate networks according to the PSPL list. The UE can choose a WLAN-network-supporting-service provider such that no other WLAN in the selected WLAN list supports a higher-priority service provider in the PSPL list. Finally, the selected realm that corresponds to the chosen WLAN-network-supporting service provider is used to create the

Network Access Identifier (NAI) for the authentication process with the service provider. 3GPP 23.003 uses the term “decorated NAI” to refer to a user identity that includes two realms. One realm can correspond to a roaming service provider while the other realm can correspond to home service providers (<homerealm>!<user>@<roamingrealm>).

Certain problems may occur when using the above-described previous approaches. In general, Wi-Fi Alliance Passpoint certified HS2.0 networks must support the mechanism. HS2.0 allows use of Operator Identifiers (OI) and use of SSIDs/HESSIDs to identify service providers. Each OI can identify a single-service provider or a roaming consortium for which the service provider is a member of. Because an OI itself is generally only 3-5 bytes, the OI can be a very efficient way to provide such identification. ANDSF will likely also adopt these OI in order to avoid using excess realms and to stay compliant with HS2.0.

A related problem also exists when performing roaming according to the base HS2.0 specification. The base HS2.0 specification does not specify the concept of a roaming service provider. If a WLAN network announces support for an OI that corresponds to a specific roaming consortium, then, according to HS2.0, the WLAN network provider should be able to access a correct home-service provider based on the NAI of the home-service provider. However, accessing a correct home-service provider based on the home-service provider NAI can be inconvenient in roaming scenarios. Accessing the home-service provider based on the home-service provider NAI can be inconvenient because, if a new home-service provider joins a roaming consortium, then every local WLAN network providing services for the roaming consortium has to be updated in order to support the new home-service-provider NAI. Specifically, a new relationship generally has to be created between every individual WLAN network operator and every new home-service provider. This new relationship could, for example, mean setting up secure Internet-Protocol-Security (IPSec) tunnels for user Authentication, Authorization and Accounting (AAA) messaging. Setting up these new relationships may be manageable when there is only a handful of WLAN network operators. However, as the number of service providers and network operators increases, setting up secure IPSec tunnels for AAA messaging may become extremely complex and practically impossible to manage.

These problematic issues also arise when using the 3GPP domain. An OI may indicate a non-3GPP specific roaming consortium. The UE generally needs to address an NAI which is a member of this consortium in order to ensure proper authentication message routing. While 3GPP assumes that a device can always use NAIs that are Public-Land-Mobile-Network (PLMN) specific, there will generally be scenarios where the WLAN network operator is not able to directly authenticate with the home service provider. In one example of such a scenario, there may be no routing for the NAI of the home-service provider in the WLAN network. A third party service provider (roaming consortium) might itself have a roaming agreement with the 3GPP operator. The UE may not know if an NAI in PSPL belongs to a roaming consortium, and the UE may not need to know if the NAI belongs to the roaming consortium. An alternative in ANDSF may use the PSPL itself. If a roaming consortium has its own NAI, then this own NAI may be added to the PSPL list, and an AP could broadcast the NAI in the NAI realm list.

HS2.0 defines a type of network selection similar to the network selection of ANDSF. In contrast to ANDSF, in HS2.0, the UE generally first searches for service providers. The UE will search for preferred WLAN network operators only if there are multiple preferred providers. HS2.0 defines how OIs, PLMNs, Realms, and SSID/HESSID values are used for service provider selection. The preferred networks are identified by Domain Ids they broadcast. HS2.0 Release 2 introduces HS2.0 Management Objects (MO) to convey this information to the UE.

Performing PLMN mapping to a realm is described in 3GPP 23.003. Also, HS2.0 defines PLMN mapping, although in a slightly different manner as compared to 3GPP 23.003. The general use of decorated NAI is defined in 3GPP 23.003 and RFC 5279. RFC 5279 defines how realms are concatenated to a user identity to create an authentication chain. RFC 5279 also defines how each authentication domain removes its own NAI from the identity when forwarding a request to a next domain. A decorated NAI may be of a form <homerealm!username@roamingconsortiumrealm>.

Embodiments of the present invention enable the use of realm-free WLAN networks by binding SSID/HESSID values and OI values with service broker realms. If a service broker is found by a UE based on the SSID/HESSID or OI values in the policy, then the realm that is associated to such a SSID/HESSID or OI value is used to create the NAI.

To address the problems associated with generic roaming consortium OI and SSID/HESSID, certain embodiments of the present invention are directed to functions of a WLAN service broker. A service broker may correspond to a regular service provider from the point of view of a WLAN AP, and the service broker may correspond to a roaming serving partner from the point of view of a UE. The service broker therefore hosts an AAA (Authentication, Authorization and Accounting) proxy. In ANDSF, and in HS2.0, authentication is executed using an Extensible-Authentication-Protocol (EAP) mechanism, contrary to using home WLAN where a shared secret is kept between the UE and the AP. In EAP, the AP outsources authentication to the external (or internal) AAA server. The UE and AAA exchanges authentication signals until authentication is complete. The AAA server will finally inform the AP about the success and will also provide master keys for 802.11 security setup (WPA2). The UE calculates its own keys itself. A service broker runs AAA proxy as the service broker generally only relays authentication messages between the home AAA server and the UE.

Local WLAN network operators can create a relationship with this WLAN service broker, and every access to the WLAN service that uses an OI for roaming consortium would be made using the realm of the service broker that is associated with the OI for the roaming consortium. The WLAN account of the home-service provider could indicate a roaming consortium realm together with the OI for the roaming consortium. If a UE accesses the WLAN network based on the roaming consortium OI or SSID/HESSID, then the UE would use the associated realm of the roaming consortium OI or SSID/HESSID, if such a realm is defined. The resulting user identity for authentication would be a generically decorated NAI of form: HomeServiceProviderRealm!user@RoamingConsortiumRealm. Otherwise, for a home user, the user identity would be of a form: user@HomeServiceProviderRealm.

When roaming between service providers, the user has to indicate a roaming service provider, a home service provider, and an actual username in the user identity that is used in the EAP authentication process. The AP (and possibly a local AAA proxy) passes authentication messages between the UE and the target AAA server. The target AAA server is derived from a local configuration using the realm of the user identity as a key. A user creates the decorated NAI for this purpose as previously described.

When the AP is connected directly to the home service provider, the UE will include only home realm and username into the user identity for authentication.

According to embodiments of the present invention, a WLAN service broker acts as a WLAN service provider for the WLAN network operator, and UEs would use the WLAN service broker as a 3GPP roaming service provider. ANDSF can apply a same mechanism itself if ANDSF includes roaming consortium OI into ANDSF policies.

Although the exact content of the PSPL has not yet been standardized, the PSPL can contain a prioritized list of service providers that are identified by their respective realms. Embodiments of the present invention can extend this by replacing a single realm with a triplet containing the realm, list of related OIs, and a list of related SSID/HESSIDs.

As an example, suppose a PSPL contains a service provider list as follows:

```
{ [realm=a.com; OIs=0x010203,0x010204;
SSID/HESSIDs=AA1/0x010203040506, AA2/*],
  [realm=b.com; OIs=0x020203,0x020204; SSID/HESSIDs=BB1/
  0x020203040506,
BB2/*] }
```

Given the PSPL list above, suppose that there is a WLAN AP that indicates service for OI=0x010204, but no realm is included, or the included realms do not match any of the PSPL entries. In this example, the UE will connect to the first WLAN network using an NAI corresponding to “a.com.” Similarly, if a UE would have detected an SSID/HESSID value such as AA1/0x010203040506, then an NAI corresponding to “a.com” would have been selected.

Alternatively, if a realm is missing from a selected PSPL entry, then this missing realm may generally be interpreted as an indication to use a Home PLMN (HPLMN) realm as an NAI. The UE is able to derive an HPLMN realm from the IMSI Mobile-Country-Code (MCC) and Mobile-Network-Code (MNC) values according to predefined 3GPP mapping between PLMN (where the PLMN corresponds to a concatenation between MCC+MNC) and NAI realm. Specifically, in HS2.0, the UE would create a realm as described above. For example, suppose that, in Finland, the MCC=244. Further, suppose that, with an operator such as TeliaSonera, the MNC=91. In this example, the resulting PLMN may be 24491, and this PLMN may be stored into a Subscriber-Identification-Module (SIM) card as a part of an International-Mobile-Subscriber-Identity (IMSI) value.

The ANDSF information may contain other indicators as to whether or not to use HPLMN realms and Roaming PLMN (RPLMN) realms when performing additional roaming in the NAI. Embodiments of the present invention can be applicable in this case as well. RPLMN-provided PSPL can be introduced into the ANDSF. In this case, for example, if OI=0x020203 is a roaming service provider partner for the RPLMN, and the RPLMN-provided PSPL list indicates to use this service provider partner, then the following decorated NAI would be derived (using the sample PSPL list above):
{ mailto:RPLMNRealm!HPLMNRealm!user@b.com}.

The access network would deliver the authentication, authorization, and accounting messages to b.com, the messages would be forwarded to RPLMNRealm and finally to HPLMNRealm. NAI decoration is defined in 3GPP 23.003 and in RFC 5729.

In order to implement the WLAN service brokers, an HS2.0 PerProviderSubscription/<X+>/HomeSP/RoamingConsortiumOI Manager Object node can be adjusted as an example. HS2.0 delivers similar policies to the UE as ANDSF does in 3GPP. Each home service provider with whom the UE has a service contract (subscription) can install network selection policies to the UE. A 3GPP operator can also push HS2.0 policies to the UE if the UE successfully authenticates to a HS2.0 AP using SIM credentials. The UE knows which WLAN networks the UE can use based on this information. This Manager Object node is currently a list of comma-delimited organizational identifiers that identifies a roaming consortium of which a service provider is a member. For example, with “010203,020203,030303”, each OI is an ASCII representation of the hexadecimal OI value (comprising 3 or 5 bytes). A realm may be associated to each OI, for example, by using ‘;’ as a delimiter. Each comma delimited ‘OI’ could be replaced with ‘OI;Realm’. If a realm is not defined, then the semi-colon would be absent too.

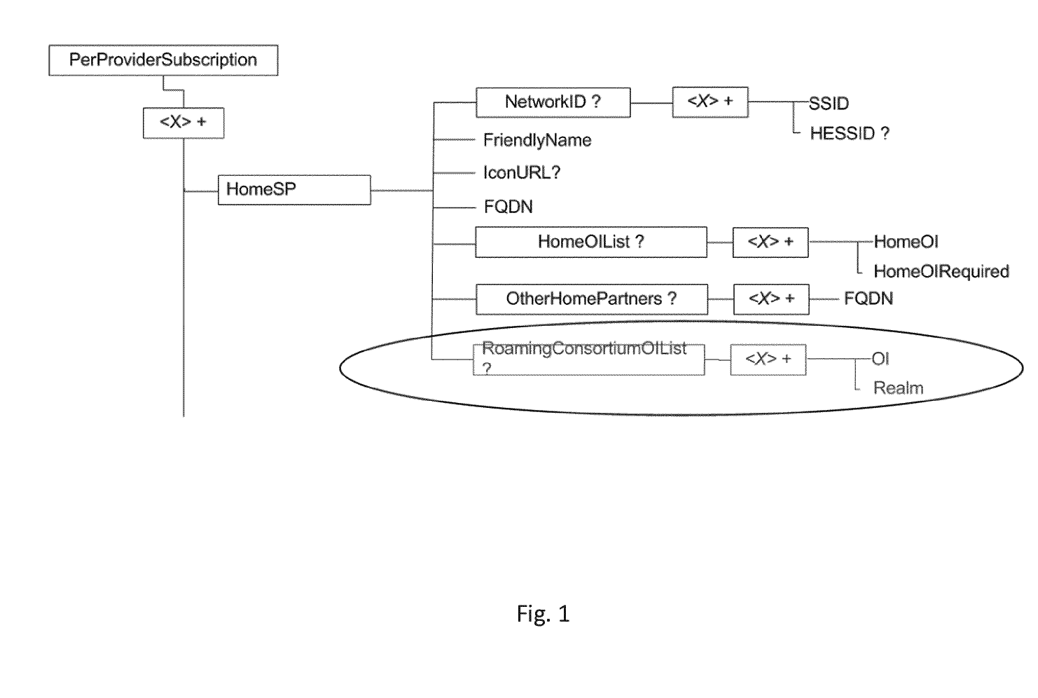

Alternatively, the HS2.0 PerProviderSubscription/<X+>/HomeSP/RoamingConsortiumOI model could be replaced with a new type PerProviderSubscriptionn/<X+>/HomeSP/RoamingConsortiumOIList, where each OI and Realm are represented separately giving leaf nodes, PerProviderSubscription/<X+>/HomeSP/RoamingConsortiumOI/<X>/OI and PerProviderSubscription/<X+>/HomeSP/RoamingConsortiumOI/<X>/Realm. FIG. 1 illustrates a Hotspot 2.0 model in accordance with one embodiment.

FIG. 1 illustrates a HS2.0 MO in accordance with Wi-Fi Alliance Hotspot 2.0 technical specification. The tree structure is a set of hierarchical information which contains users subscription data including network selection policies. PerProviderSubscription/<X+> is an instance of one Wi-Fi HS2.0 subscription. All subscription data are placed under this node. The <X+> is a notion to indicate one or more cardinality. There could be nodes like PerProviderSubscription/1 and PerProviderSubscription/2 for two different subscriptions from a same service provider. Different service providers are similarly separated in parent objects which are not visible here.

PerProviderSubscription/<X+>/HomeSP includes data about a home service provider. It contains a list of roaming consortium OIs to which the subscription is entitled to.

Similarly, when RoamingConsortiumOIs are introduced into the ANDSF, the Realm could be associated to them in the same way. Each roaming consortium could be associated with a priority as well. This association would allow prioritization of a roaming consortium, as the cost of using specific roaming consortiums can be different for the home service providers. The UE would generally prefer high-priority roaming consortiums over lower-priority consortiums.

Also, the PerProviderSubscription/<X+>/HomeSP/NetworkID/<X+> element could also be associated with a Realm value. The HS2.0 device can select service providers based on the SSID/HESSID values in NetworkID elements, similar to RoamingConsortiumOI's. If a WLAN service broker identifies its networks using SSID/HESSID, then the WLAN service broker may also indicate the realm that is to be used to access the network. If the UE chooses a service provider based on the SSID/HESSID values, then the UE would use an associated realm and create a decorated NAI, which includes both this realm and a home service provider realm. Similar to RoamingConsortiumOIList, NetworkID elements may also have associated priority.

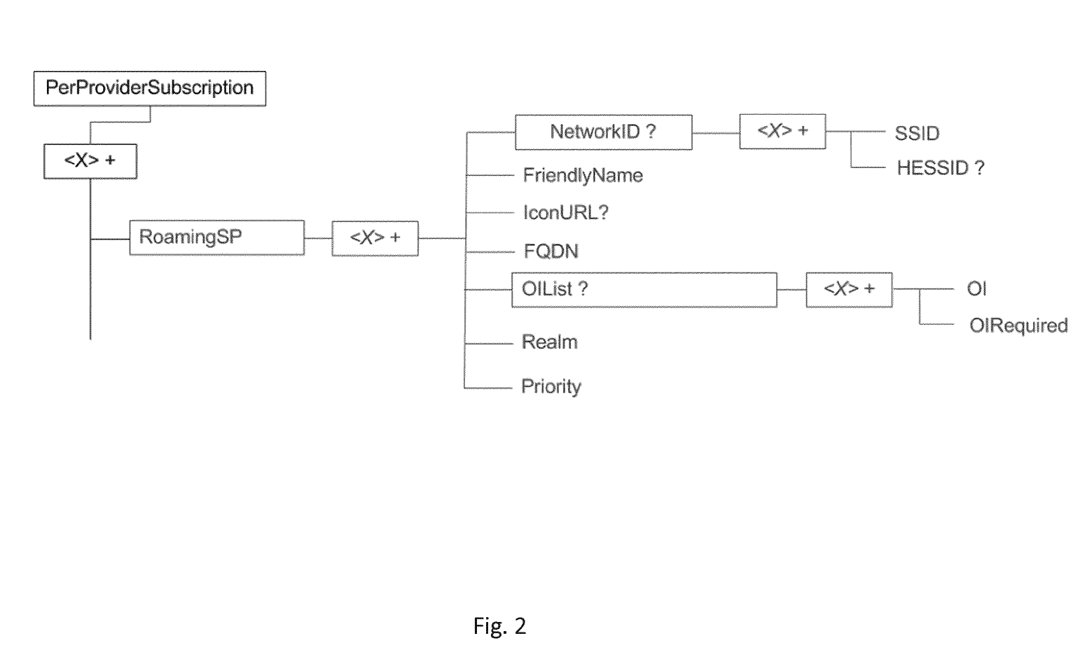

FIG. 2 illustrates a Hotspot 2.0 model in accordance with another embodiment. Embodiments of the present invention may separate the WLAN service broker uses into a new HS2.0 Management Object branch, without modifying an existing Home-Service-Provider (HomeSP) node and usage at all. HomeSP would generally be searched, and all these networks would be used directly with the home service provider credentials. There may be no modification to existing behavior. If home networks are not found, the UE would consider roaming service providers under the RoamingSP node, as illustrated by FIG. 2. Each roamingSP entity would generally have an associated priority, and a service provider with highest priority is generally preferred over lower priority networks.

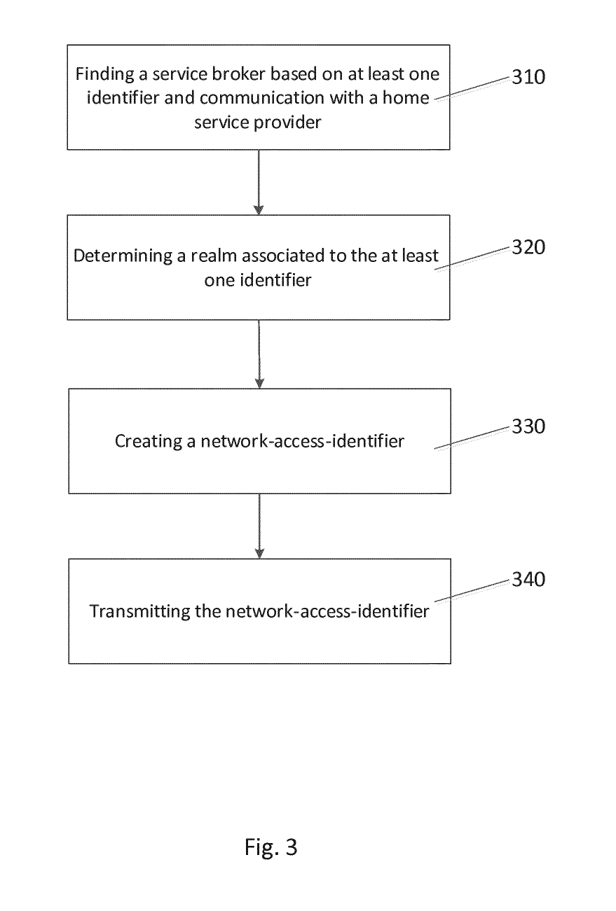

FIG. 3 illustrates a logic flow diagram of a method according to certain embodiments of the invention. The method illustrated in FIG. 3 includes, at 310, finding, by a user equipment, a service broker based on at least one identifier and communication with a home service provider via this service broker. The service broker acts as a proxy service provider for a service provider like the home service provider. The method, at 320, includes determining a realm associated to the at least one identifier. The method, at 330, includes creating a network-access-identifier based on the determined realm. The method, at 340, includes transmitting the network-access-identifier to the service broker for performing authentication of the user equipment in the home service provider.

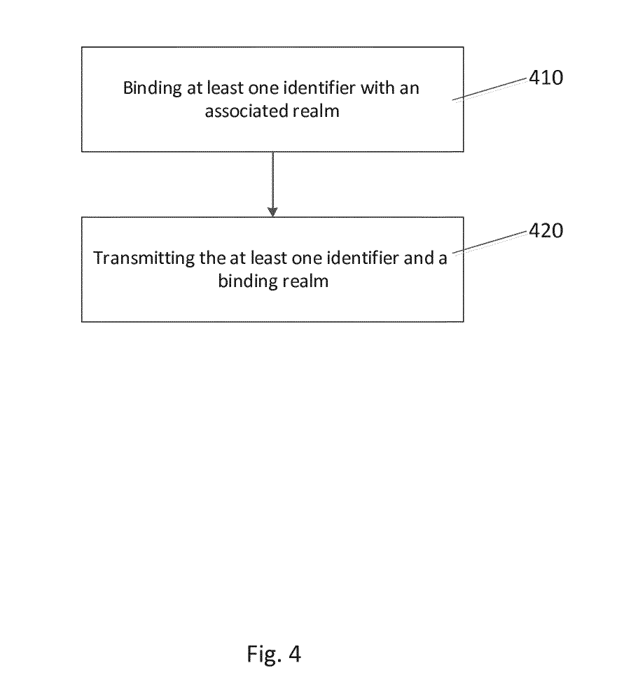

FIG. 4 illustrates a logic flow diagram of a method according to certain embodiments of the invention. The method illustrated in FIG. 4 includes, at 410, binding, by a network node, at least one identifier with an associated realm. The method also includes, at 420, transmitting the at least one identifier and a binding realm to a user equipment. The transmitting includes communicating with a service broker.

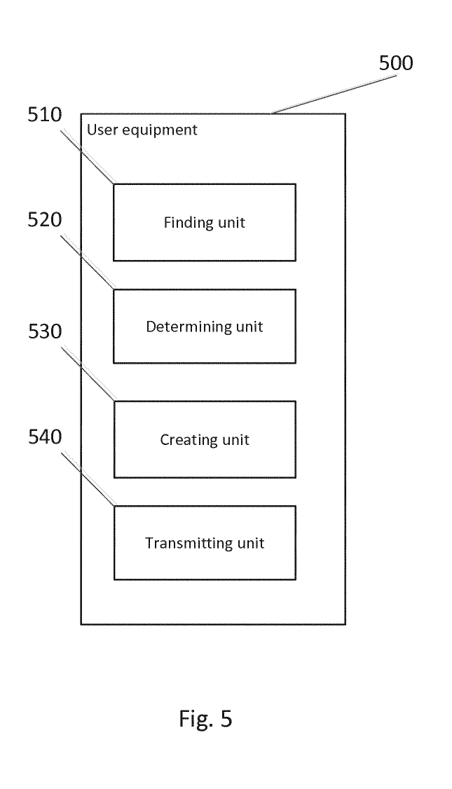

FIG. 5 illustrates an apparatus in accordance with one embodiment. Apparatus 500 includes a finding unit 510 that finds a service broker based on at least one identifier and communication with a home service provider via this service broker. The service broker acts as a proxy service provider for a service provider like the home service provider. Apparatus 500 also includes a determining unit 520 that determines a realm associated to the at least one identifier. Apparatus 500 also includes a creating unit 530 that creates a network-access-identifier based on the determined realm. Apparatus 500 also includes a transmitting unit 540 that transmits the network-access-identifier to the service broker for performing authentication of the user equipment in the home service provider.

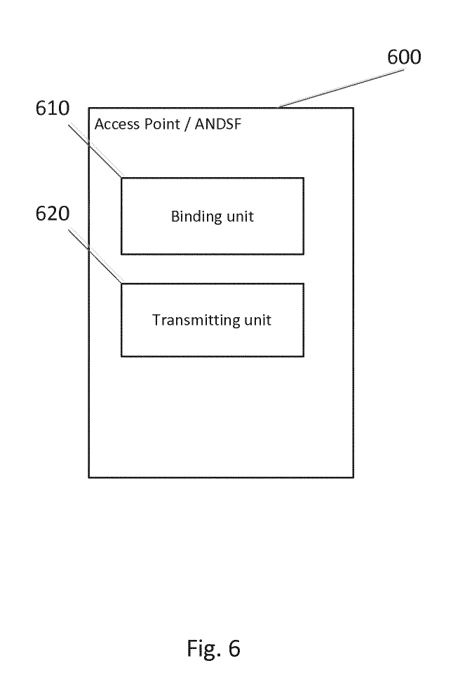

FIG. 6 illustrates an apparatus in accordance with one embodiment. The apparatus 600 includes a binding unit 610 that binds at least one identifier with an associated realm. The apparatus 600 also includes a transmitting unit 620 that transmits the at least one identifier and a binding realm to a user equipment. The transmitting includes communicating with a service broker.

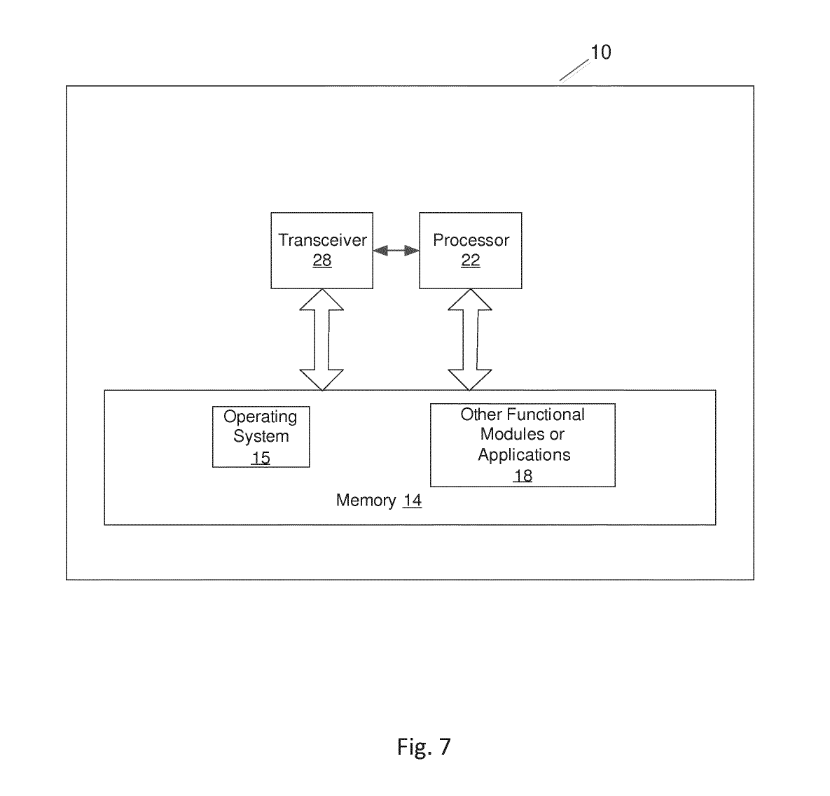

FIG. 7 illustrates an apparatus 10 according to embodiments of the invention. Apparatus 10 can be a device, such as a UE, for example. In other embodiments, apparatus 10 can be a base station, network server, and/or access point, for example. Apparatus 10 can also include a network node that performs the functions of ANDSF and/or HS2.0, for example.

Apparatus 10 can include a processor 22 for processing information and executing instructions or operations. Processor 22 can be any type of general or specific purpose processor. While a single processor 22 is shown in FIG. 7, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In certain embodiments, memory 14 stores software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

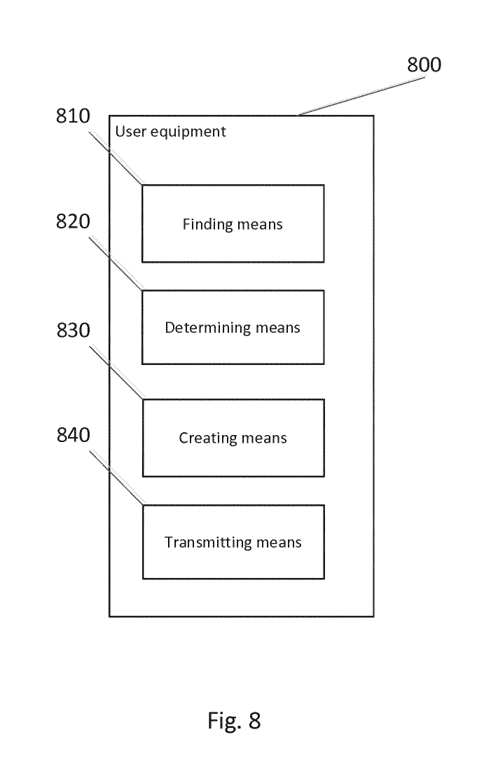

FIG. 8 illustrates an apparatus in accordance with one embodiment. Apparatus 800 includes a finding means 810 that finds a service broker based on at least one identifier and communication with a home service provider via this service broker. The service broker acts as a proxy service provider for a service provider like the home service provider. Apparatus 800 also includes a determining means 820 that determines a realm associated to the at least one identifier. Apparatus 800 also includes a creating means 830 that creates a network-access-identifier based on the determined realm. Apparatus 800 also includes a transmitting means 840 that transmits the network-access-identifier to the service broker for performing authentication of the user equipment in the home service provider.

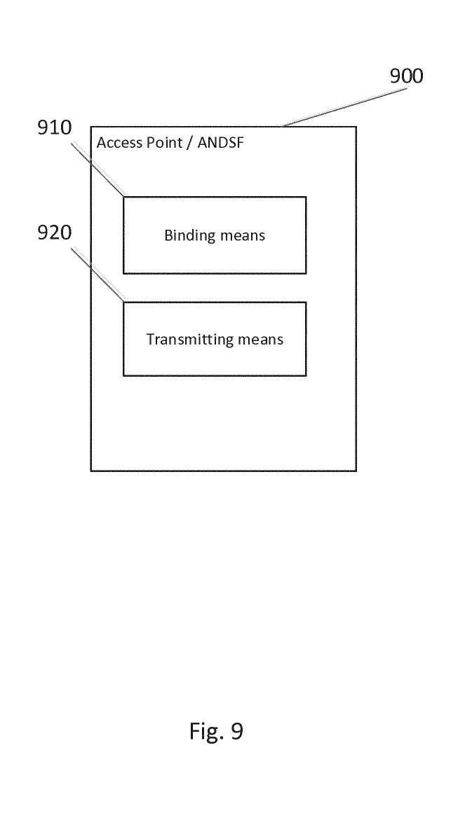

FIG. 9 illustrates an apparatus in accordance with one embodiment. The apparatus 900 includes binding means 910 that binds at least one identifier with an associated realm. The apparatus 900 also includes transmitting means 920 that transmits the at least one identifier and a binding realm to a user equipment. The transmitting includes communicating with a service broker.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
finding, by a user equipment, a service broker based on at least one identifier and communication with a home service provider via this service broker, wherein the service broker acts as a proxy service provider for a service provider like the home service provider;
determining a realm associated to the at least one identifier;
creating a network-access-identifier based on the determined realm; and
transmitting the network-access-identifier to the service broker for performing authentication of the user equipment in the home service provider.

2. The method according to claim 1, wherein the finding the service broker comprises finding the service broker while the user equipment is roaming

3. The method according to claim 1, wherein the finding the service broker based on the at least one identifier comprises finding the service broker based on at least one of service-set-identifiers, homogenous-extended-service-set-identifiers, and organizational identifiers.

4. The method according to claim 1, wherein the finding the service broker comprises finding a wireless-local-area network.

5. The method according to claim 1, wherein the finding the service broker comprises finding a service broker based on at least one of service-set-identifiers, homogenous-extended-service-set-identifiers, and organizational identifiers in a home service provider network selection policy that is delivered to the user equipment.

6. An apparatus, comprising:
at least one processor; and
at least one memory including computer program code,
the at least one memory and the computer program code configured, with the at least one processor, to cause the apparatus at least to
find a service broker based on at least one identifier and communication with a home service provider via this service broker, wherein the service broker acts as a proxy service provider for a service provider like the home service provider;
determine a realm associated to the at least one identifier;
create a network-access-identifier based on the determined realm; and
transmit the network-access-identifier to the service broker for performing authentication of the apparatus in the home service provider.

7. The apparatus according to claim 6, wherein the finding the service broker comprises finding the service broker while the apparatus is roaming

8. The apparatus according to claim 6, wherein the finding the service broker based on the at least one identifier comprises finding the service broker based on at least one of service-set-identifiers, homogenous-extended-service-set-identifiers, and organizational identifiers.

9. The apparatus according to claim 6, wherein the finding the service broker comprises finding a wireless-local-area network.

10. The apparatus according to claim 6, wherein the finding the service broker comprises finding a service broker based on at least one of service-set-identifiers, homogenous-extended-service-set-identifiers, and organizational identifiers in a home service provider network selection policy that is delivered to the apparatus.

11. (canceled)

12. A method, comprising:
binding, by a network node, at least one identifier with an associated realm; and
transmitting the at least one identifier and a binding realm to a user equipment, wherein the transmitting comprises communicating with a service broker.

13. The method of claim 12, wherein the binding comprises binding at least one of service-set-identifiers, homogenous-extended-service-set-identifiers, and organizational identifiers with the associated realm.

14. The method of claim 12, wherein the transmitting the at least one identifier to the user equipment comprises transmitting the at least one identifier in a home service provider network selection policy.

15. An apparatus, comprising:
at least one processor; and
at least one memory including computer program code,
the at least one memory and the computer program code configured, with the at least one processor, to cause the apparatus at least to
bind at least one identifier with an associated realm; and
transmit the at least one identifier and a binding realm to a user equipment, wherein the transmitting comprises communicating with a service broker.

16. The apparatus of claim 15, wherein the binding comprises binding at least one of service-set-identifiers, homogenous-extended-service-set-identifiers, and organizational identifiers with the associated realm.

17. The apparatus of claim 15, wherein the transmitting the at least one identifier to the user equipment comprises transmitting the at least one identifier in a home service provider network selection policy.

18. (canceled)
